(19) United States
(12) Patent Application Publication
(10) Pub. No.: US 2024/0386618 A1
(43) Pub. Date: Nov. 21, 2024

(54) Conversion of Text to Dynamic Video

(71) Applicant: Jeffrey Jay Collier, II, Austin, TX (US)

(72) Inventor: Jeffrey Jay Collier, II, Austin, TX (US)

(21) Appl. No.: 18/132,974

(22) PCT Filed: Oct. 20, 2021
(86) PCT No.: PCT/US2021/055924

§ 371 Date: Apr. 11, 2023

Related U.S. Application Data
(63) Continuation of application No. 63/104,184, filed on Oct. 22, 2020.

(51) Int. Cl. G06T 11/00; G06F 40/169; G06F 40/279; G06F 40/40; G06T 13/40

(52) U.S. Cl. CPC G06T 11/00; G06F 40/169; G06F 40/279; G06F 40/40; G06T 13/40

(57) ABSTRACT

The approach described herein for transforming text to video starts with one or more users writing a screenplay, which includes text with optional annotations and metadata describing a video, and sending it to a software system wherein the following five primary steps may be taken to generate and/or distribute a video: edit, transform, build, render, and distribute. These processes can happen in different orders at different times to enable the creation or display of a video. All five steps are not always required to render a video and at times, processes may be combined or their sub-processes expanded into their own separate process.

### CROSS REFERENCE TO RELATED APPLICATIONS

This application claims priority to PCT application number PCT/US21/55924, which claims priority to U.S. provisional patent application No. 63/104,184, the contents of which are incorporated by reference in their entirety.

### FIELD OF THE INVENTION

The present disclosure relates to the field of video production using software. Specifically, this disclosure relates to a software methodology for converting text to video.

### BACKGROUND OF THE INVENTION

Currently when creating or producing a video, the usual first step is to write a “screenplay” describing what will happen in the video including, among other things, action sequences, dialogue, and camera direction. The screenplay will then go through various revisions until it is ready to be manually produced, which may use a combination of animation software, physical cameras, and actors. This process can take from days to years just to complete a single video.

Additionally, any changes, including those for advertising, language, or dialogue are difficult to change once the video has been distributed.

Therefore, what is needed is a technique to streamline the video production process, preferably including the ability to dynamically change the content of a video without going through the long manual video production process.

The present invention solves this problem.

### SUMMARY OF THE INVENTION

In a preferred embodiment of the present invention, the approach described herein for transforming text to video starts with one or more users writing a screenplay, which includes text describing a video, and sending it to a software system wherein the following five primary steps may be taken to generate and/or distribute a video, these steps include edit, transform, build, render, and distribute. These processes may occur in different orders or at different times to enable the creation or display of a video. All five steps are not always required to render a video and at times, processes may be combined or their sub-processes expanded into their own separate process.

### DESCRIPTION OF THE DRAWINGS

The present invention will be understood more fully from the detailed description disclosed below and from the accompanying drawings of various embodiments of the present invention. The detailed description and drawings are intended to illustrate specific embodiments of the present invention and are not intended to limit the present invention. These specific embodiments are for explanation and understanding purposes only.

This approach is illustrated by way of example and is not limited to the figures in the accompanying drawings.

FIG. 1 shows high-level steps the system takes to transform text to video.

During each major stage, status updates may be given to the user enabling the user to provide feedback on how to proceed in the event of an error or an unknown situation.

FIG. 2 shows an example of the “edit” step 200.

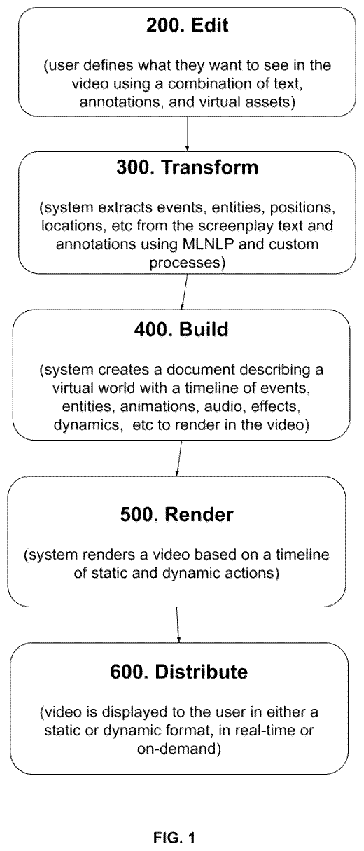

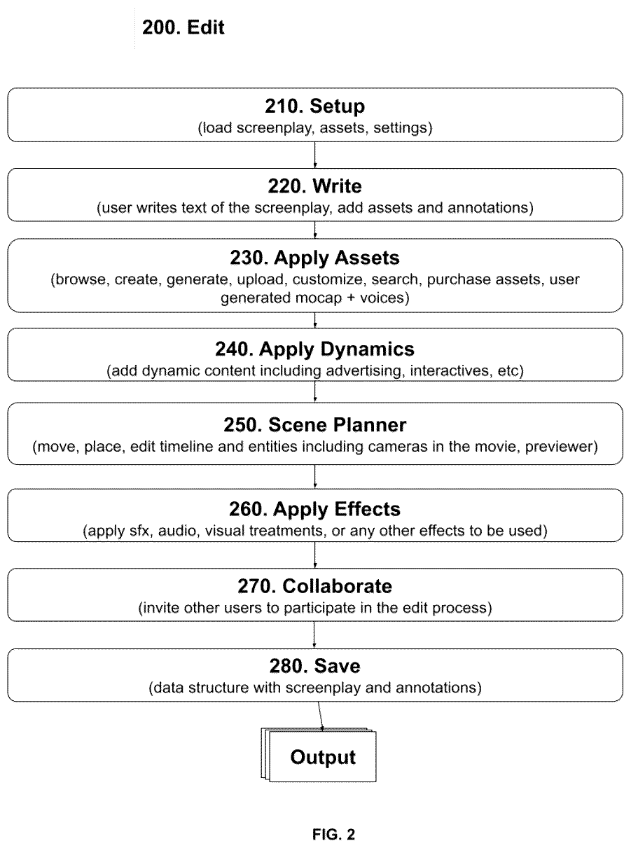

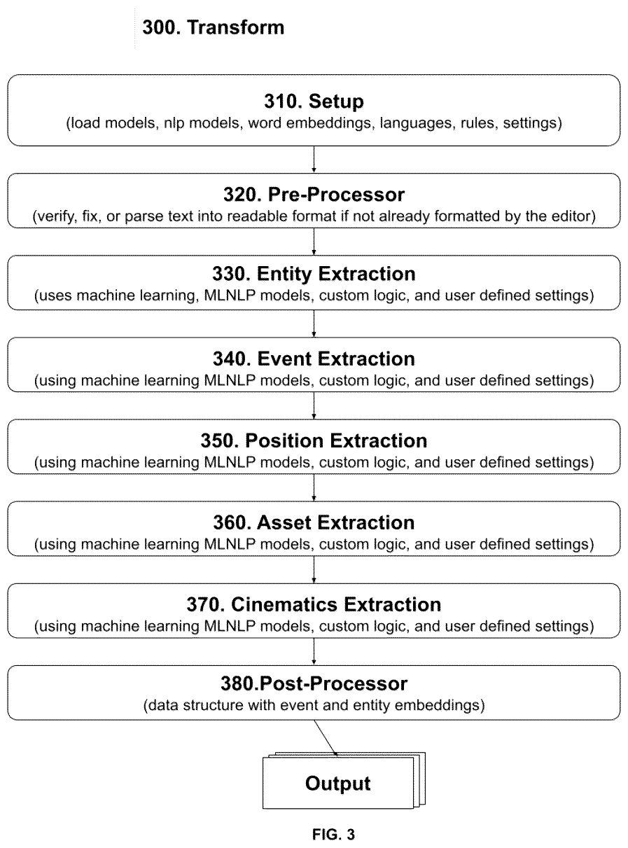

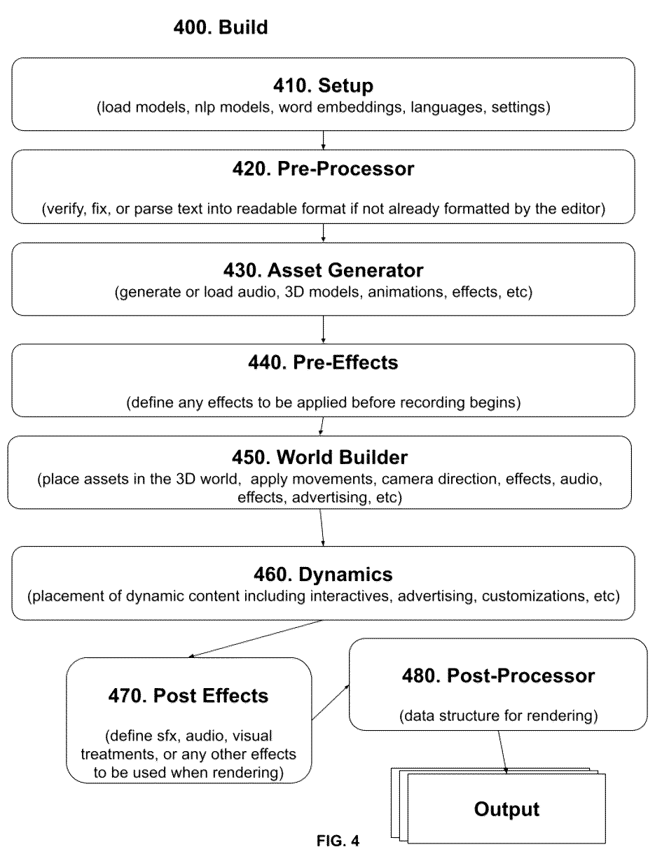

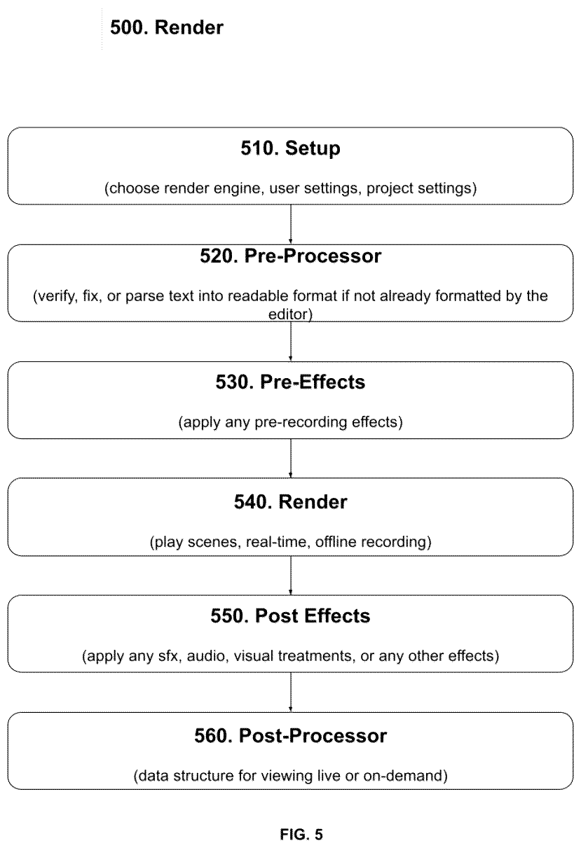

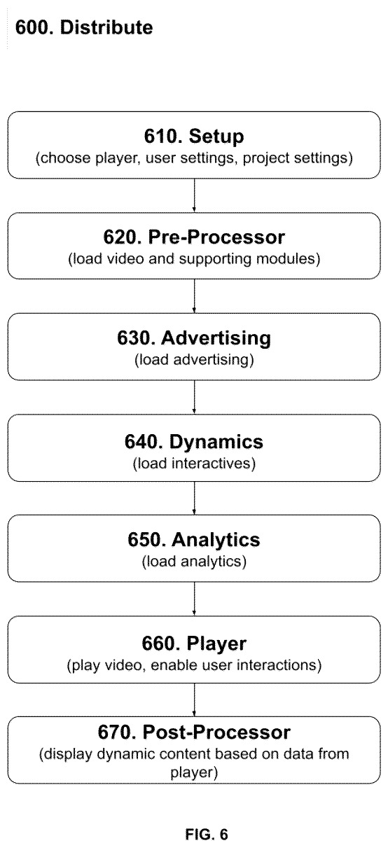

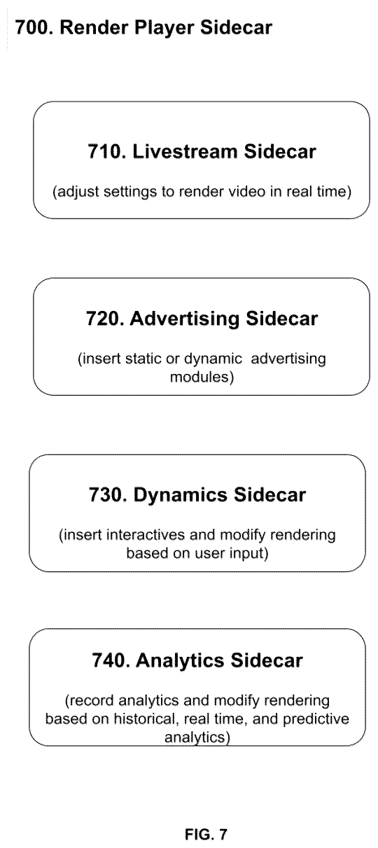

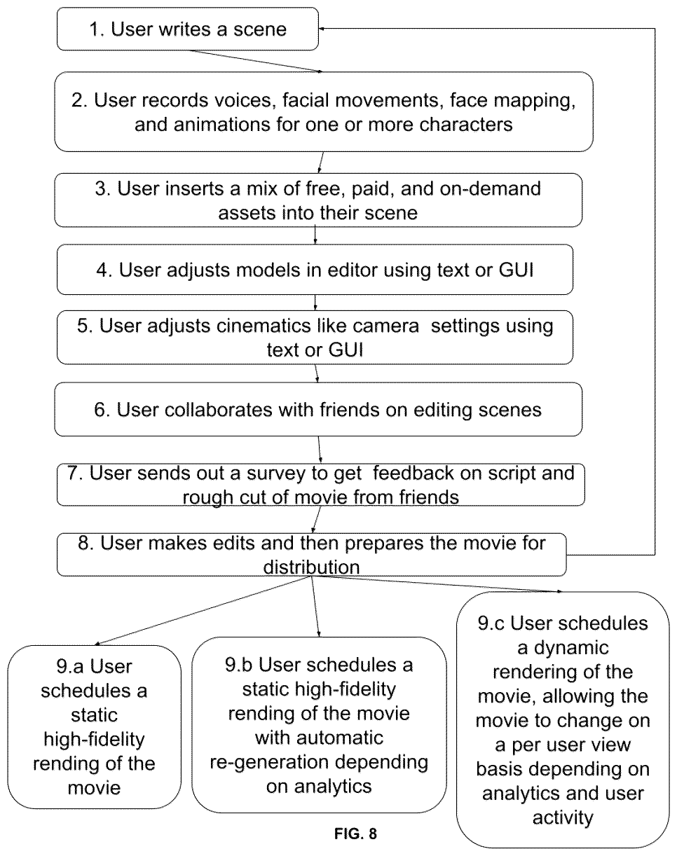

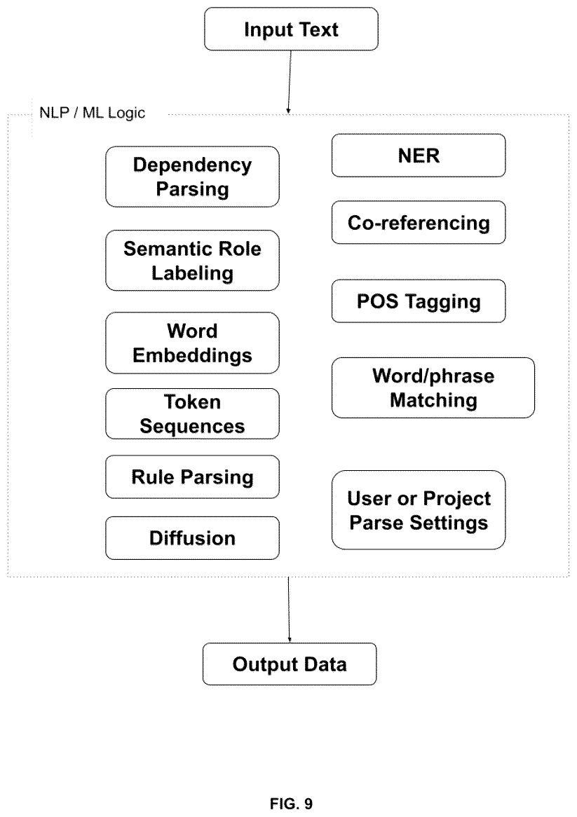

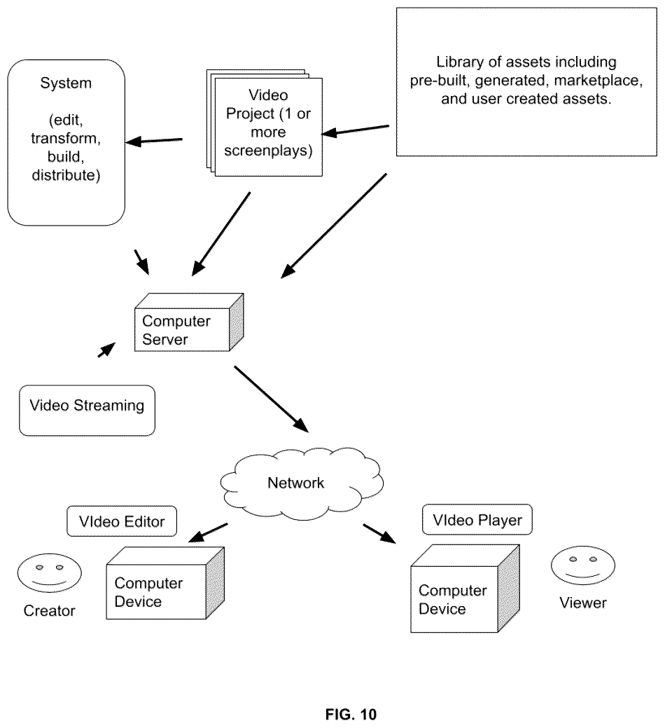

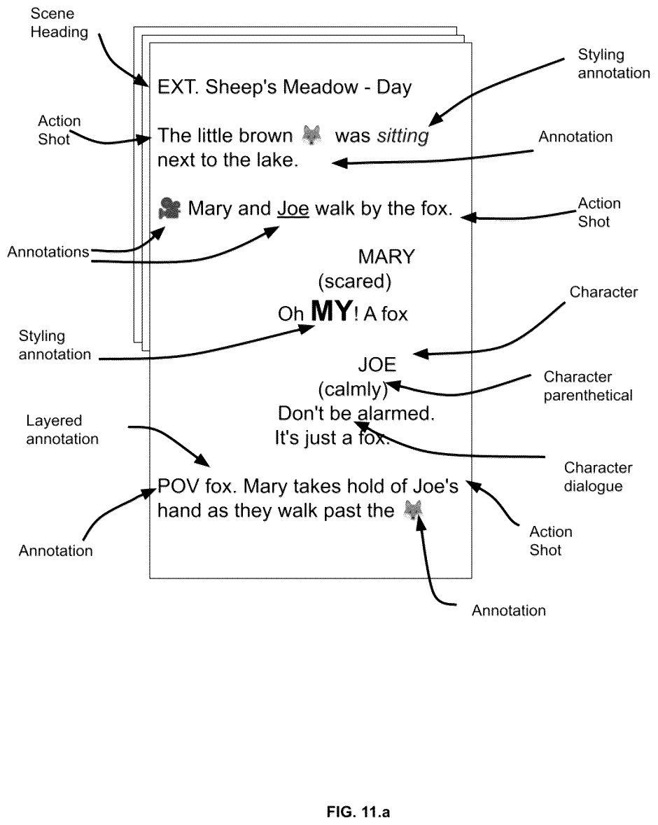

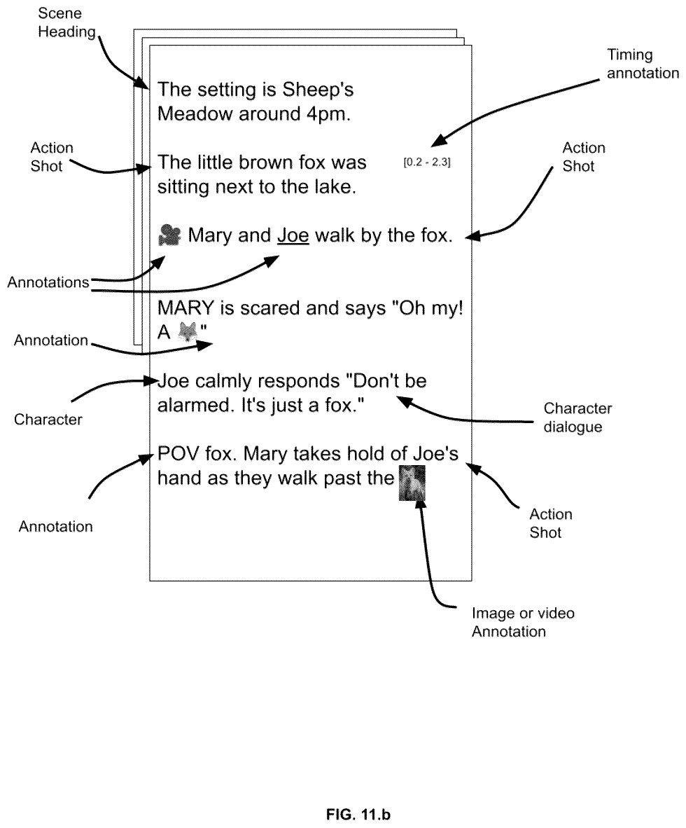

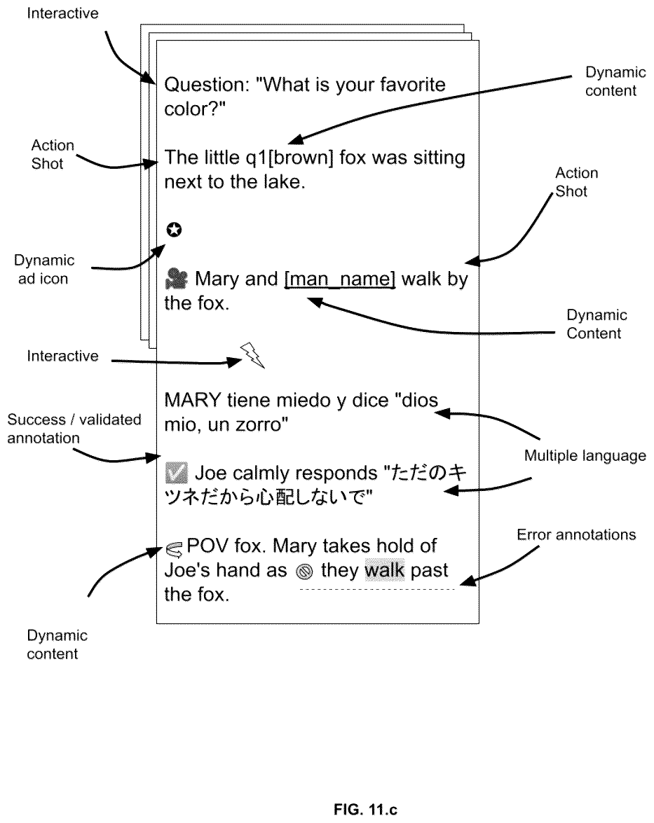

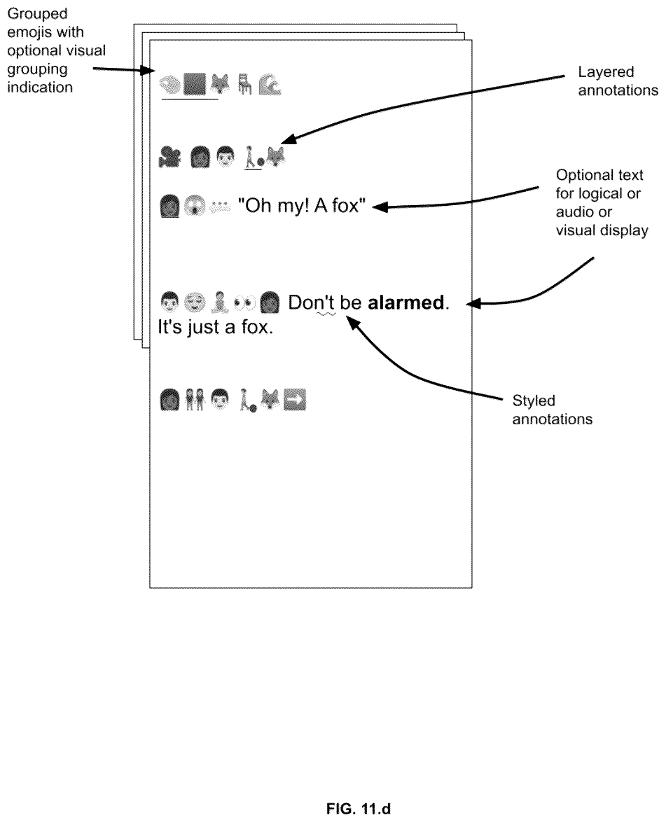

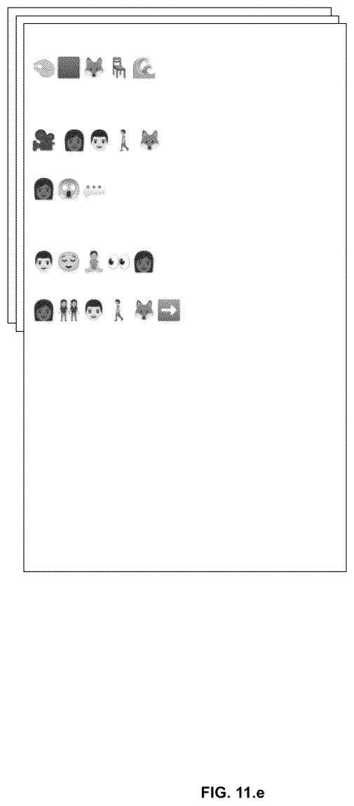

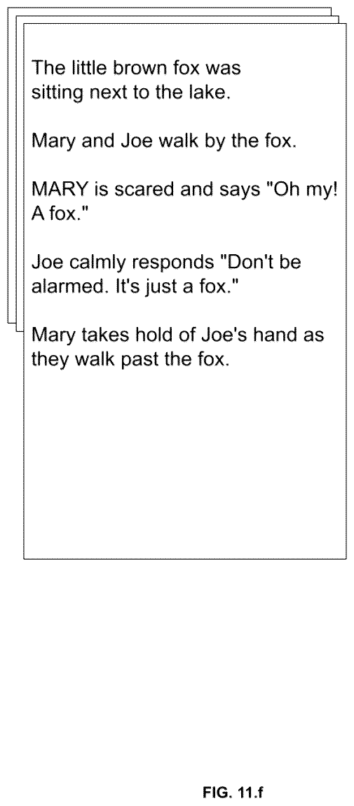

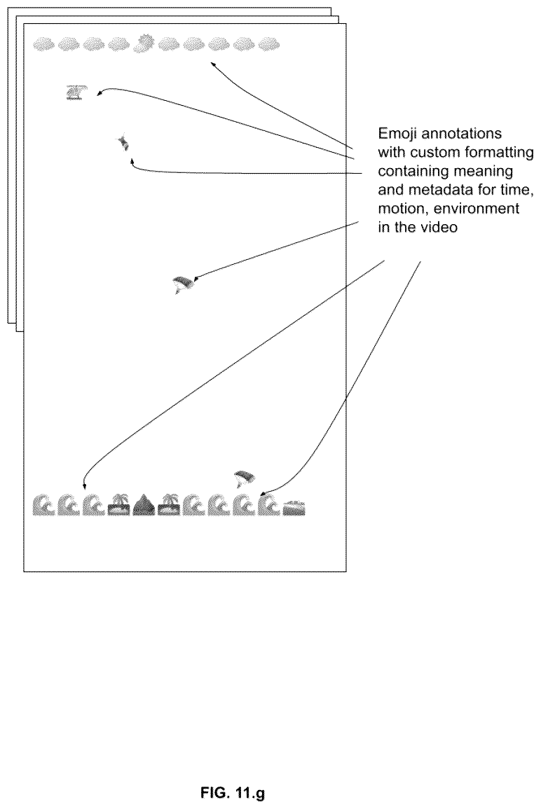

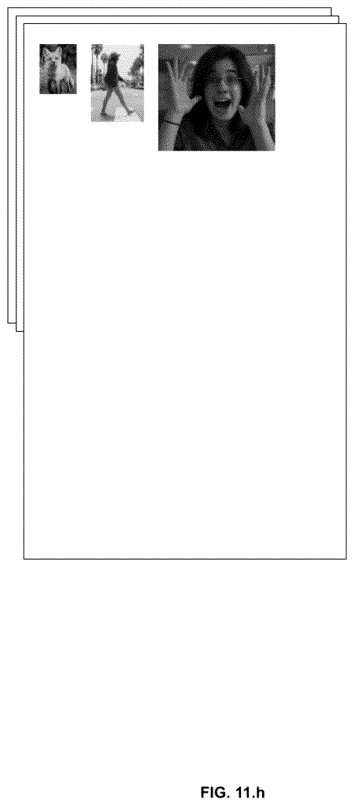

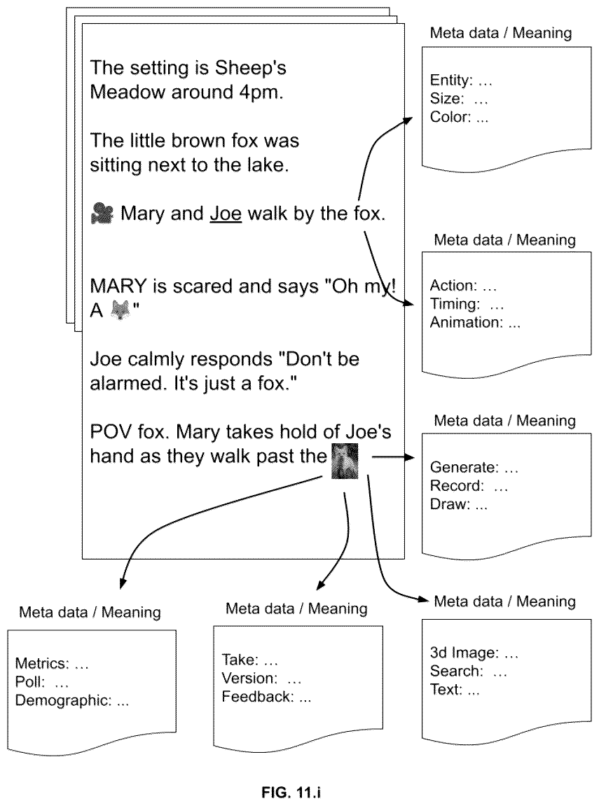

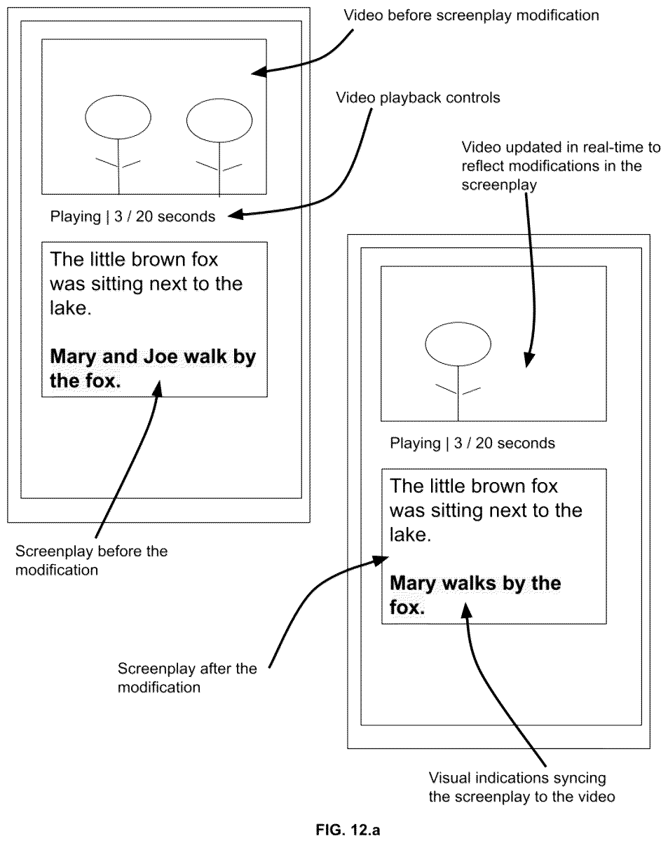

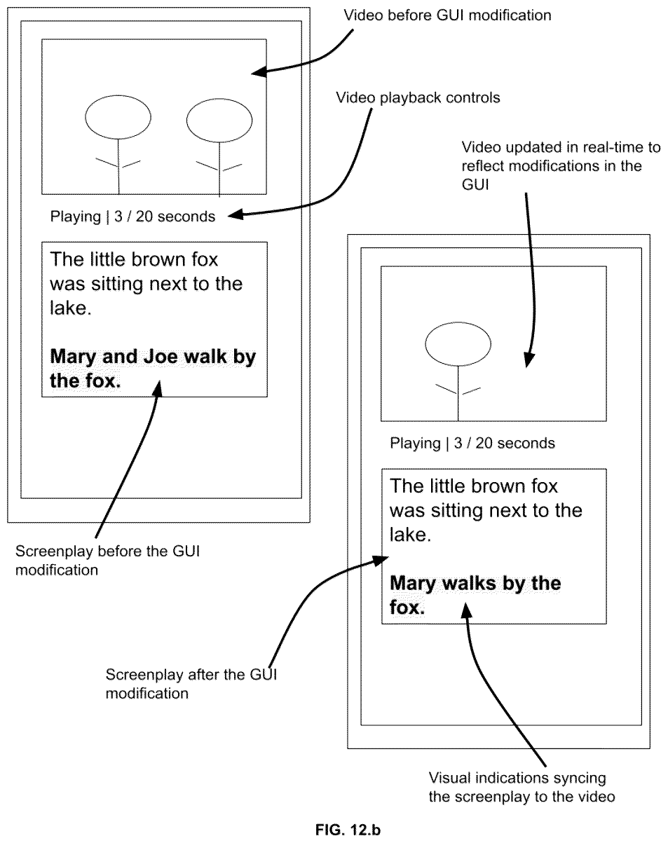

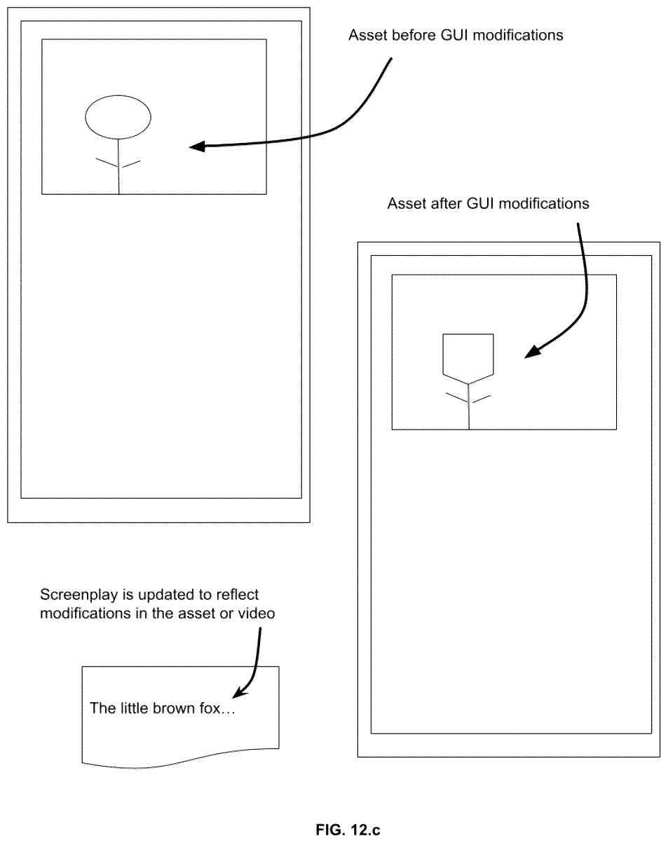

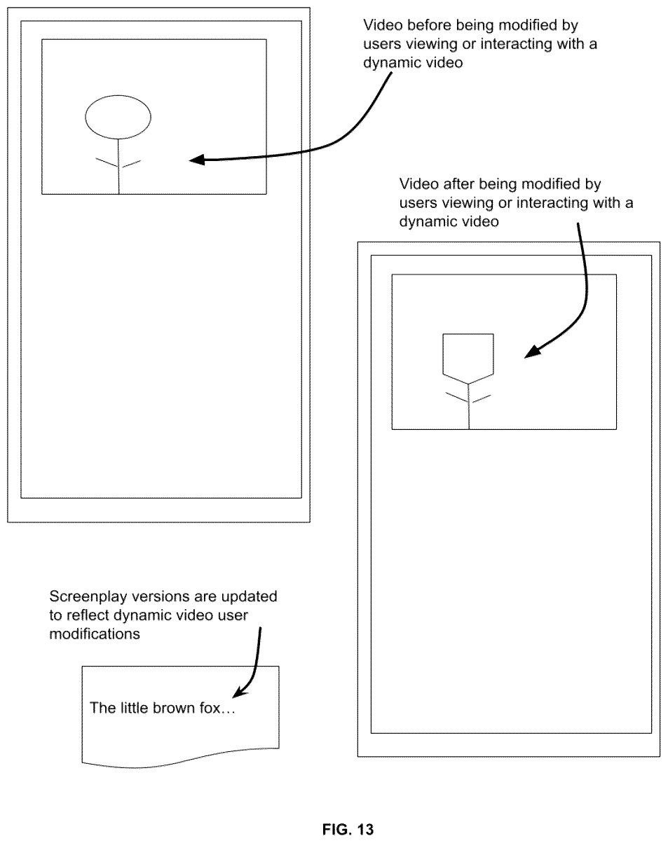

The “edit” step enables the user to write a screenplay and apply non-textual annotations to the screenplay. The screenplay can be written by one or more users and receive feedback from one or more users. The screenplay format is not constrained to any single format, style, or encoding. The screenplay format can be changed based on context or user preference.

220. User writes a screenplay in plain or rich text with annotations from any input device including a keyboard, computer API, VR headset, eye tracking, microphone, scanned image, recorded video, camera, handwriting, or gestures such as sign language. The text and rich text can be in any language, in any font, any font styling, and in any character encodings or character sets including but not limited to Unicode (UTF-8, UTF-16, UTF-32), ASCII, ISO/IEC 8859-1. The text and rich text can be decorated with styles to indicate metadata or meaning for each word, words, or sentence. The annotations can be represented but not limited to any static image, 3d image, animated image, video, 3d video, 3d object, audio, pictogram, logogram, ideogram, emoticon, emoji, glyph, symbol, mark, grapheme, code point, or typographical approximation. Annotations can be grouped or layered together to represent new annotations. Both text, rich text, and annotations can contain metadata or meaning that the user can manipulate in the text or GUI tool. Examples of metadata or meaning include emotion, color, time, intensity, position, audio, shape, relationship, movement, animation, focus, genre, language, geography, as well as others.

230. User optionally applies any static or dynamic assets to the screenplay from a variety of sources including the user's custom-made assets, software assets present in system libraries, paid assets provided in a marketplace, assets the present invention generates dynamically, and assets uploaded by the user. Assets can include a 3D object, sound, voice recording, musical recording, video recording, image, animation, video, cameras, text, special effects, mocap, maps, signal data, point cloud data, vertex data, bone data, facial features, as well as others.

240. User may optionally apply dynamics to the screenplay including user interactions, including questions, click zones, voice responses, reactions, movement; dynamic content, including coloring, scene location, and character age; advertising, and other options. This system allows the user to produce a traditional “static” video that is generated once, wherein the content of the video does not change. The system may also generate a dynamic video wherein the content of the video changes, based on, for example, who is viewing or interacting with the video. “Dynamics” is meant to cover all types of interactive or dynamic content. Examples of dynamic content include changes in entities, events, advertising, interactives, color of an object, movement, user input, location of a scene, dialogue, language, scene order, or audio. Use examples include inserting targeted advertising, testing different video variations for groups of users, changing content, dialogue or characters based on the user. For example, a PG versus R rating, user preferences, country, or survey results; allowing the user to change the camera angle; “choose your own adventure’ style video; a training or educational video where a user has to answer a question; adjust video based on user feedback or actions; allow the user to insert their own dialogue or face or animations or characters as they are watching. Interactives allow the viewer(s) of the video to interact with the video. Examples include answering questions, selecting areas on the screen, exploring the video, reactions, keyboard presses, or mouse movements.

250. User optionally applies fine grain positioning of assets and creation of any scene, for example using text or a GUI tool.

260. User optionally applies special effects to the screenplay, for example using text or a GUI tool.

270. User optionally collaboratively writes with other users and/or receives feedback from other users in the form of comments, anonymous reviews, surveys, and other feedback mechanisms.

Output. Document containing information related to the textual representation of the video, including the screenplay text, screenplay text formatting, annotations, assets, dynamics, settings, versions. Data for documents in the software system can be stored in one or more formats on one or more computer devices. For example, the document data can be stored in whole or part, in a single file, or multiple files, or a single database, or multiple databases, or a single database table, or multiple database tables. In the event of a “live stream” or “collaboration,” the data may be sent in real time to other users or computer devices. This output may be referred to as an annotated screenplay.

FIG. 3 shows an example of the “transform” step 300.

The “transform” step converts the text into a computer readable format describing the major events and entities, for example characters, objects in the video.

330. Uses machine learning natural language processors (MLNLP) to determine words in the text that are entities to render in the video.

340. Uses MLNLP to extract a timeline of events happening in the text to render in the video, for example walking, running, eating, or driving.

350. Uses MLNLP to determine the timeline of positioning of entities and events in the video.

360. Uses MLNLP to determine any additional assets to be rendered in the video including sounds.

370. Uses MLNLP to determine any cinematics such as camera movements, special effects, and more.

Output. Document containing some or all of the input data along with the events, entities, and other extracted data parsed from the screenplay and ordered in a sequence of events to be rendered in the video. Document storage options are the same as in previous steps. This output may be referred to as a sequencer.

FIG. 4 shows an example of the “build” step 400.

The “build” step converts the output from the “transform” step into a virtual representation of the video in computer readable format.

430. Based on input, generate assets required to render the video. This includes dialogue voices, background music, scenery, character design, and any other assets to be used in the video. Assets can be a mixture of premade, user influenced, user designed, user created, or computer generated. Generated assets will use the context of the screenplay, annotations, text, format, metadata, genre, user preferences, demographics, algorithms, and machine learning to determine the asset data.

440. Based on input, add any special effects to apply during the rendering such as particle effects, fog, or physics.

450. Based on input, create a virtual representation of the video the “render” process can interpret to render a video. This includes camera positions, lighting, character movements, animations, and more.

460. Based on input, apply dynamic content logic into the output.

470. Based on input, apply any special effects or post-processing effects required to properly render the video.

Output. Document containing some or all of the input data along with a “virtual world” of detailed instructions required to render the video including describing the world, entities in the world, including audio, special effects, or dynamics, and the series of actions/events that occur within the world. This includes but is not limited to character positions, character meshes, dynamics, animations, audio, special effects, transitions, shot order, and more. Document storage options are the same as in previous steps. The output may be referred to as the virtual world.

FIG. 5 shows an example of the “render” step 500.

The “render” step converts output from the “build” step to create one or more dynamic videos in a variety of formats including 2D, 3D, AR, VR. The render process may include sub-render processes that happen before, during, and/or after a user is viewing the video.

530. Apply special effects to the scene and world of the video.

540. Render the video based on the virtual representation and dynamic content and advertising.

550. Apply post-processing special effects and editing to achieve the desired video.

Output. Document of the rendered video in one or more formats. Possible formats include 2D, 3D, AR, VR, or other motion or interactive formats. Document storage options are the same as in previous steps.

FIG. 6 shows an example of the “distribute” step 600.

The “distribute” step displays the video with optional dynamic interaction, content, and advertising.

630. Apply advertising of any format to the video zero or more times.

640. Apply dynamic content to the video zero or more times.

660. Video player to display the video along with any user interactions with the video.

FIG. 7 shows an example of a “render player sidecar.”

Describes the “render player sidecar” allowing static or real-time rendering of a video using dynamic interactions, content, and advertising. This optionally enables the people viewing the video to interact with the video including the video acting more as a video game than passively viewed video.

The sidecar can reside in the video itself, the video player, or a helper library.

710. Enables livestream controls to have authors of the screenplay write and distribute the video in real time.

720. Applies advertising to the video statically or upon viewing in a variety of forms including pre-rolls, commercials, product placement, in-video purchases, and more.

730. Applies dynamic content to the video statically or upon viewing including interactives and changing content based on user preferences, behaviors, and general analytics.

740. Records user behavior when viewing or interacting with the video.

FIG. 8 describes a potential use case of the system.

FIG. 9 describes a high-level machine learning approach to converting the text into a computer readable format that can be rendered into a video during steps 330-370.

The input text is analyzed by one or more MLNLP modeling tools to extract and identify entities and actions in the text. The system then applies layers of logic to determine various properties such as position, color, size, velocity, direction, action, and more. In addition to standard logic, custom settings on a per user or project are applied for better results.

FIG. 10 describes at a high-level a potential use case for resources, networking, and communication.

FIG. 11.a describes a typical “screenplay” format with annotations.

FIG. 11.b describes a casual “screenplay” format with annotations.

FIG. 11.c describes a dynamic “screenplay” with multiple languages and dynamic content including ads and interactives.

FIG. 11.d describes a “screenplay” with emoji annotations and text.

FIG. 11.e describes a “screenplay” with only annotations.

FIG. 11.f describes a “screenplay” with only text.

FIG. 11.g describes a “screenplay” with formatting of the annotations providing meaning and metadata in the video.

FIG. 11.h describe a “screenplay” with only image or video annotations.

FIG. 11.i describes examples of metadata that may be associated with annotations or text in a “screenplay”.

FIG. 12.a describes GUI tools for real-time video editing using the screenplay.

FIG. 12.b describes GUI tools for real-time video editing using the GUI tool.

FIG. 12.c describes GUI tools for asset editing of screenplay or global assets.

FIG. 13 describes screenplay and video modifications from users viewing or interacting with dynamic video.

### DETAILED DESCRIPTION OF THE INVENTION

In the following description, for purposes of explanation, numerous specific details are set forth in order to provide a thorough understanding of the invention. It will be apparent, however, to one skilled in the art, that the invention can be practiced without each specific detail.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following example, there are five main processes to generate and render a video: edit, transform, build, render, distribute. These processes can happen in different orders at different times to enable the creation or display of a video.

### Edit Process

The “edit” process enables a user to create a video project with one or more files and at least one of those files containing the screenplay and other files containing other assets used in the creation of the video, preferably in a format proprietary to our system or in a format typically used by writers in the film and TV industry. The exact format may differ as the user can annotate the text with non-standard information from a library of options, including but not limited to camera movements, sound, and other assets including 3d models.

In addition to selecting from a library of pre-built options and assets, the user can create their own assets, import assets, purchase assets from our marketplace, or hire custom built assets from a marketplace of vendors on our platform. The options and assets include but are not limited to sound, facial expressions, movements, 2D models, 3D models, VR formats (Virtual Reality), AR formats (Augmented Reality), images, video, maps, cameras, lights, styling, and special effects.

Users can modify metadata the edit process to influence the creation of the video. Metadata provides additional context and detail on how the video is created by defining one or more attributes on any aspect of the video including but not limited to text, annotations, entities, assets, movements, maps, images, videos, audio, timing, and emotion.

Users can select from a library of pre-defined annotations, text, formats, and styles or they can create their own. Annotations, text, formats, and styles can be generated by the system based on the context of the user, screenplay, or system.

The meaning and grouping of annotations, text, styles, formatting, and other components can be identical for all users and screenplays, or they can be modified by the user or modified by the system, or generated by the system based on the context of the user, screenplay, or system data.

Annotations, text, formats, and styles can be specific for a single user or screenplay. Annotations, text, formats, and styles can also be shared across multiple users or screenplays.

The system can provide the user with generation services including system generated text for the screenplay, 3d models, maps, audio, lighting, camera angles, or any other component used in a video.

At the user's discretion a video can be created based on their screenplay script. Our system gives the user a variety of rendering options to choose from including rendering time, quality, and preview.

Portions of the video can be exported including video, images, sounds, assets, 2d, 3d data, VR, AR, or entities.

Automatic and manual versioning of the project and related files is available to the user. The user will be able to view versions inline or separately.

Our system has the ability to give feedback to the user about how their screenplay will be processed and the state of processing including any sub-processes at any point in time. This can include how their screenplay is parsed, rendering status, errors, generative works, previews, and other users making changes to the screenplay.

In addition to editing the text and annotations, the user can modify their screenplay using one or more visual GUI tools. Some of these GUI tools include but are not limited to viewing the video in different specifications; controlling the video playback (watching the video); modifying the screenplay resulting in real-time updates to the video while the video is playing or paused; exploring the video from different camera angles or positions while the video is playing or paused; modifying any asset or entity in the video while the video is playing or paused; modifying metadata of any asset or entity in the video while the video is playing or paused; modifying metadata of any asset or entity in the video outside of the context of the video; modifying any asset or entity in the video outside of the context of the video; recording text, audio, video, timing, metadata, annotations, assets, entities, or 3d data; modifying text, audio, video, timing, metadata, annotations, assets, entities, or 3d data; searching for text, audio, video, timing, metadata, annotations, assets, entities, or 3d data; viewing modifications from other users.

When the user modifies the video using GUI tools their screenplay is automatically updated to reflect the modifications. Visual indications, formats, text, styles or annotations in the screenplay may update to reflect the GUI modifications by the user.

Collaboration with other users is enabled at the discretion of the user. This can include viewing, commenting, editing, and deleting all or part of the screenplay. Certain portions of the screenplay can be redacted for different users. Additionally, feedback in the form of comments, surveys, and more can be sent to registered or anonymous users.

### Transformer Process

The “transformer” process will convert input data including plain text, rich text, annotations, formats, styles, assets, and metadata into entities, assets, settings, timelines, and events used to inform the creation of a video. These entities, assets, settings, timelines, and events include but aren't limited to characters, dialogue, camera direction, actions, scene, lighting, sound, time, emotion, object properties, movements, special effects, styling, and titles.

The transformer will use a series of machine learning models and other techniques including but not limited to dependency parsing, constituency parsing, coreference analysis, semantic role labeling, part of speech tagging, named entity recognition, grammatical rule parsing, word embeddings, word matching, phrase matching, genre heuristic matching to identify, extract, and transform the input data into meaningful information and components.

Based on feedback from users and system processes, the transformer preferably will improve its ability to process and generate text.

Based on previous operation of system processes, the transformer may edit input data and parse logic of the input to generate new or modify input data or generate a new screenplay programmatically.

### Builder Process

Input data will be used by our “world builder” process to create a virtual representation of the video bringing together all the required assets, entities, settings, logic, timelines, and events for the video.

Proprietary modeling along with input data will be used to determine all aspects of the video including entities, assets, placement, movement, style, and timing. Some or all elements of the video will be dynamic based on logic or inputs.

Optional computer generation of video assets for the virtual world may be applied based on user settings, project settings, or automatically when the system detects a need. Assets include but are not limited to maps, scenery, characters, sound, lighting, entity placements, movements, camera, and artistic style. Entities refer to files, data or other items displayed in a video, including characters and objects. The generation will be informed by one or more sources including user settings, trained models, story context, screenplay project files, user feedback, videos, text, images, sounds, annotations, metadata, format, styles, and outputs from system processes.

### Render Process

Input data will be used by our “render” process to create one or more output videos in a variety of formats including 2D, 3D, AR, VR.

The render process for the video can occur on one or more devices residing on internal or external system computer systems or applications including the user's computer, web browser, or phone. The video rendering may happen one or more times, and may happen before, during, or after a user views the video based on a variety of inputs. The video render process may use other processes to complete the rendering.

During the render process one or more rendering techniques may be used to create desired effects or styling in the video.

Security and duplication mechanisms will be applied at various stages of processing to ensure compliance with system requirements. These mechanisms can include digital and visual watermarks.

The user who created the video will be able to modify the video including editing scenes, overlaying assets, adding dynamic content, interactives, commerce settings, advertising settings, privacy settings, distribution settings, and versioning.

Videos have the ability to be static or dynamic allowing assets, entities, directions, advertising, commerce mechanisms, or events to change before, during, or after a user views the video. Inputs for these changes can be based on video settings, system logic, user feedback, user interaction, user geography, user language, user device, or user activity.

The “render player sidecar” enables the generation of dynamic videos before, during, or after it is being distributed.

Project settings, user settings, and system logic will determine how and when a video is viewed by users.

### Distribute Process

Input data will be used by our “distribute” process to display dynamic videos generated during the “render” process.

Some videos created during the “render” process will be static and viewable outside of our software system.

Other videos, especially dynamic videos, will only be playable on our software system or compatible software systems. When a video is played it can be displayed in its current form, modified, or generated in real-time to enable the video to change based on a variety of settings or inputs including but not limited to user preferences, user activity, user interaction, user geography, user language, user device, user device controls, and ad-settings. Variations of the video can be saved for future use.

Users or the system can enable interactions between users watching a set of one or more videos. The system can modify or generate the video offline or in real-time to reflect the users watching or interacting with a set of videos. User interactions include but are not limited to commenting, discussing, voting, reactions, recording, promoting, video streaming, audio streaming, VR interactions, real-time screenplay modifications, real-time GUI modifications of the video, real-time video camera modifications, and participating in video interactives.

The “render player sidecar” modifies the video based on a variety of inputs and can be embedded in the video, player, or act as an intermediary to communicate with the “render” process to change the video if the video is unable to modify itself without intervention.

It is understood that this invention is not limited to only the elements described herein and that other types of elements will be equivalent for the purposes of this invention. The invention has been described by referencing preferred embodiments and several alternative embodiments, however one of ordinary skill in the art understands that employing other variables and modifications does not depart from the spirit and the scope of the present invention.

Although the invention has been disclosed in terms of specific embodiments herein, in light of these teachings, one of ordinary skill in the art may generate additional embodiments and modifications without departing from the spirit or the scope of the claimed invention. It is understood that the examples and descriptions disclosed herein are merely to facilitate understanding of the invention and should not be construed to limit the scope thereof.

What is claimed is:

1. A method for automatically converting text to dynamic video, the method comprising:
accessing an annotated screenplay;
transforming the annotated screenplay to a sequencer;
building a virtual world from the sequencer; and
rendering the virtual world into a video.

2. The method disclosed in claim 1, the method further comprising editing wherein a user may annotate text with non-standard information from a library of options.

3. The method disclosed in claim 1, the method further comprising distributing to display dynamic videos generated during the rendering process.

4. The method disclosed in claim 1, further comprising utilizing machine learning to transform text into meaningful visual information and components.

5. The method disclosed in claim 1, further comprising utilizing machine learning natural language processors to determine words in text that are entities to render in video.

6. A method for automatically converting text to static video, the method comprising: accessing an annotated screenplay;
transforming the annotated screenplay to a sequencer;
building a virtual world from the sequencer; and
rendering the virtual world into a video.

7. The method disclosed in claim 1, the method further comprising editing wherein a user may annotate text with non-standard information from a library of options.

8. The method disclosed in claim 1, the method further comprising distributing to display dynamic videos generated during the rendering process.

9. The method disclosed in claim 6, further comprising utilizing machine learning to transform text into meaningful visual information and components.

10. The method disclosed in claim 6, further comprising utilizing machine learning natural language processors to determine words in text that are entities to render in video.
